(19) United States
(12) Patent Application Publication
(10) Pub. No.: US 2023/0400014 A1
(43) Pub. Date: Dec. 14, 2023

(54) SYSTEM AND METHOD FOR PRODUCING CLEAN, SUSTAINABLE, AND ACCESSIBLE ENERGY WITH AIR, SAND, AND WATER (ASW) AS POWER SOURCES, A SOYOS ENVIRONMENT CLEAN ENGINE (SECE)

(71) Applicants: ULRICH NDILIRA ROTAM, FARMINGTON, NM (US); MILLARD MANASSET NDILIRA, FARMINGTON, NM (US)

(72) Inventors: ULRICH NDILIRA ROTAM, FARMINGTON, NM (US); MILLARD MANASSET NDILIRA, FARMINGTON, NM (US)

(21) Appl. No.: 17/838,216

(22) Filed: Jun. 12, 2022

(51) Int. Cl. F03G 7/10

(52) U.S. Cl. CPC F03G 7/104; F05B 2260/40312; F05B 2260/4023; F05B 2260/4022; F05B 2260/60

(57) ABSTRACT

A system and method for producing clean, sustainable, and accessible energy with air, sand, and water (ASW) as power source a soyos environment clean engine (SECE) having a clean stroke maker system (CSM) mounted on a solid upraise structure (SUS), to produce continuous mechanical energy for inner work and input to a plurality of rotary table systems (RTS), transforming to rotational energy for more power and coupled to the clean energy collector (CEC) with a plurality of retract clutch system (RCS). The clean energy collector (CEC) is connected to a customized Torque-Speed builder (CTS) for stable power, generating continuous clean, sustainable, and available energy for various carbon-zero emissions activities. A plurality of internal control using air, sand, and water (ASW) interconnected and interacted with the air force, gravity force and water force creating compressed air energy, hydro energy, mechanical energy for internal exchange and clean power delivery.

### FIELD OF THE INVENTION

The present invention generally relates to a system and method for producing clean, sustainable, and accessible energy with air, sand, and water (ASW) as power sources for a soyos environment clean engine (SECE). More specifically, the present invention is the power machine to generate clean energy that combines a strict choice of free carbon emission natural resources available with fewer problems air, sand, and water (ASW) as a power source for a variety of internal work exchange and conversion to allow the complete system to generate clean power. The present invention can be used in various applications specifically for environmental help and advantages in all seasons with less cost to produce electricity in power plant station, to supply electricity to the electric motor in multiple industries with less cost to the users compared to the prior arts and reducing carbon dioxide emission in the atmosphere to fight climate change.

### BACKGROUND OF THE INVENTION

Climate change is concerning all of us on Earth. The Earth has been warming very fast over the past hundred years. In only two hundred seventy-five years, considering using chemical resources from fossils, coals, and gas to produce power for different activities, keep increasing too much carbon dioxide emission into our atmosphere, and the Earth is at a critical temperature raising. The growing population on Earth needs more clean power capacity to satisfy their necessities. Helping the Earth for our lives and future generations by combating climate change by reducing carbon dioxide emissions is a priority. Our traditional power production with immense pollution keeps putting our planet in a hard-living place in the universe. Many alerts from different locations worldwide reduce energy with CO2 and prioritize renewable energy for our future and fight climate change.

In the prior art of energy production, particularly in renewable energy, many different types have been developed to help users with environmental issues. We must thank all these signs of progress. Wind, hydropower, and solar energy technology are the most available hope in this tough fight, and they are coming with more improvements at more costs. Still, wind and solar come with the leading natural problems in their availability. They are renewable power over a day, seasons, and regions. Energy storage is essential to boost those technologies for the continuous flow of electricity; still, with the high cost and low autonomy for significant demand. Nuclear energy comes with hope; Still, with high cost and waste management issues to the environment and populations. The waterpower derived from motion with weight, the different potential, and gravity energy is also used in many prior arts as old technics and modern to generate electricity. The cost and less efficient technics are common challenges needing more innovations to improve this area. They are not at the limit today to respond positively and fast to this complex battle on climate change. Most of those technologies keep producing more carbon dioxide into our atmosphere to obtain materials to put them alive, and the Earth is heating very fast.

Therefore, what is clearly needed is a simple and more available new method of clean energy production to satisfy the different sectors to combat climate change at a large scale with a fast response to the reduction of carbon dioxide emission at a different level. Give clean energy availability everywhere on the Earth, available at any season, and efficient with more advantages than prior arts with less cost and more minor damage to the environment. It is an object of the present invention to improve renewable energy on prior arts and solve these issues by introducing: a system and method for producing clean, sustainable, accessible energy with “Air-Sand-Water” (ASW) as a “power fuel source,” creating compressed air, hydro, and mechanical energy for internal work exchange and for clean power delivery, a “soyos environment clean engine” (SECE). This invention allows users to obtain clean energy with easy access for safe use, carbon emission-free at production, and at less cost.

No prior arts seem to meet renewable resources such as “Air-Sand-Water” (ASW) combined and used as a “clean fuel source” with zero carbon dioxide emission for internal work exchange and to produce clean, sustainable, accessible power. In this invention, a system and method of generating clean, sustainable, and accessible energy are named “soyos environment clean engine” (SECE). To improve and provide more access to clean energy for different activities, with the best quality and less costly production of electricity to population, to different power types of electric motors for various activities, to operate at any time and any season to help Earth environment with zero pollution in multiple industries. An additional advantage of the present invention will be set forth and learned by practice.

### SUMMARY OF THE INVENTION

The primary objective of the present invention is to produce clean and sustainable energy to be available with zero carbon dioxide emission and zero pollution to our environment. The present invention uses a combination of air, sand, and water (ASW) as clean sources of production. This choice solves many problems with natural resources that create energy with more environmental issues on earth and lower costs to the population with zero carbon emissions at a different level to fight climate change. Providing the users an efficient power source with the large availability of renewable energy at any time and everywhere on earth.

To obtain those as mentioned above, the present invention provides a system and method for internal communication to produce clean, sustainable, and accessible energy with air, sand, and water (ASW) as power sources, a soyos environment clean engine (SECE). The present invention is a clean stroke maker (CSM) system used for giving a continuous stroke cycle. A plurality of a “soyos drop piston” (SDP) aligned in parallel and standing in elevation to be attached to the solid upraise structure (SUS) with a plurality of connections to a clean energy collector (CEC). One soyos drop piston (SDP) provides a piston with zero carbon emission communicates in sequential cycles to give a continuous piston to the clean energy collector (CEC). The soyos drop piston (SDP) comprises: a head angle extender system, a principal capsule tank (PCT) attached with wheels on a principal vertical travel line (VTL) mounted on two vertical round pipes (VRP), a capsule catcher system (CCS) installed on top, a brake-pump chamber (BPC) and the main water pump (MWP) both installed at the bottom, with a system of wire cable control configured for efficient internal mechanical works exchange. The secondary vertical travel line (VTL) comprises a head angle extender system, a secondary capsule tank (SCT) attached to two vertical round pipes (VRP) with wheels on a secondary vertical travel line (VTL).

A system of wire cable control and a bar control system interconnected the system for efficient internal works exchange. Both capsules are attached together with a wire chain traversing a bearing handle supports, a chaincase, a chain extender control, and the main sprocket teeth on a rotary table system (RTS). Each principal capsule tank (PCT), filled with liquid water at the top, travels to the bottom with a large amount of weight superior to the secondary capsule tank (SCT) filled with sand, adjusting the weight to be superior to the empty principal capsule tank (PCT). The system is configured to imbalance both capsules to produce significant mechanical energy converted to rotational energy on the rotary table for more power delivery and to create compressed air energy and hydro energy for internal work in exchange for continuous operation for the entire system. A solid upraise structure (SUS) comprises an upward and downward tank using water in liquid to operate. An optional fill with water plus an antifreeze additive to bump down the freezing point or raise the boiling point to allow water in liquid at any site in cold and hot weather for operating in all seasons worldwide.

The Clean Energy Collector (CEC) is a mechanical system that comprises a solid shaft, left and right flywheel, and a main sprocket at the center being aligned and coupled with a transmission chain to a personalized torque-Speed (PTS). A plurality of input sprocket of the clean energy collector (CEC) aligned on both sides of the main sprocket with solid support. It is configured to be aligned and coupled with transmission chains to a plurality of the rotary table system (RTS). A plurality clutches teethes on a plurality of the rotary table system (RTS) collecting in continue the rotational power to the main sprocket of the clean energy collector (CEC). The mechanical energy is converted to rotary energy. The clean energy collector (CEC) is transmitted a clean, sustainable, available energy in continuing to a customized Torque-Speed builder (CTS) to allow the user for different external works. The user can extend the clean power delivery for this new invention: soyos environment clean engine (SECE) for his various need for clean energy jobs in many sectors. The user can also expand this present invention at a large scale for a fast carbon dioxide emission reduction battle to tackle climate change.

### BRIEF DESCRIPTION OF DRAWINGS

The accompanying drawings, incorporated in and constitute a part of this disclosure, illustrate various embodiments of the present invention. The drawings contain representations of various trademarks and copyrights represented owned by the applicants. All rights to various trademarks and copyrights represented herein are vested in the applicants' property. The Applicants retain and reserve all rights in their trademarks and copyrights included herein and grant permission to reproduce the material only in connection with reproduction of the granted patent and for no other purpose.

FIG. 1A illustrates a top view of an elevation of a solid upraise structure (SUS) holding a clean stroke maker (CSM) system according to one embodiment of the present invention.

FIG. 1B is an elevated view showing a clean stroke maker (CSM) system according to some embodiments of the present invention.

FIG. 1C illustrates a view of a single soyos drop piston (SDP) according to some embodiments of the present invention.

FIG. 1D is a front view showing a solid upraise structure (SUS) according to some embodiments of the present invention.

FIG. 2A is the left view of a solid upraise structure (SUS) connected to a clean stroke maker (CSM) system with a plurality of automatic internal command system (ICS) connected to a clean energy collector (CEC), according to some embodiments of the present invention.

FIG. 2B is the elevated view of a clean energy collector (CEC) positioning with a customized Torque-Speed builder (CTS) according to one embodiment of the present invention.

FIG. 2C is a front view of a soyos environment clean engine (SECE) according to the preferred embodiment of the present invention.

FIG. 2D is a side view of a soyos environment clean engine (SECE) according to the preferred embodiment of the present invention.

FIG. 3A is the flow chart illustrating a method showing the steps of communication for operating a soyos environment clean engine (SECE) according to one embodiment of the present invention.

FIG. 3B is a continuation of the flow chart FIG. 3A illustrates a method showing the steps of communication for operating a soyos environment clean engine (SECE) according to one embodiment of the present invention.

FIG. 3C is a continuation of the flow chart FIG. 3B illustrates a method showing the steps of communication for operating a soyos environment clean engine (SECE) according to one embodiment of the present invention.

FIG. 3D is a continuation of the flow chart FIG. 3C illustrates a method showing the steps of communication for operating a soyos environment clean engine (SECE) according to one embodiment of the present invention.

FIG. 3E is the flow chart illustrating a method showing the steps of communication for operating a clean energy collector (CEC) according to some embodiments of the present invention.

FIG. 3F is the flow chart illustrating a method showing the steps activating a clutch on a rotary table system (RTS) according to some embodiments of the present invention.

FIG. 3G is the flow chart illustrating a method showing the steps of deactivating a clutch on a rotary table system (RTS) according to some embodiments of the present invention.

FIG. 3H is to illustrate a cycle timeline schematic showing the complete one cycle operating a clean stroke maker (CSM) system according to some embodiments of the present invention.

FIG. 4 is the perspective view of a clean energy collector (CEC) connected to a customized Torque-Speed builder (CTS) according to some embodiment of the present invention.

FIG. 5 is the top view of a customized Torque-Speed builder (CTS) with a component connected according to one embodiment of the present invention.

FIG. 6A illustrates a view of a clean stroke maker (CSM) system according to some embodiments of the present invention.

FIG. 6B shows an example of one soyos drop piston (SDP) according to some embodiments of the present invention.

FIG. 6C illustrates a top view showing an example of a solid upward structure (SUS) according to some embodiments of the present invention.

FIG. 7A illustrates a front view of a soyos drop piston (SDP) according to some embodiments of the present invention.

FIG. 7B illustrates a top view of a soyos drop piston (SDP) according to some embodiments of the present invention.

FIG. 8 is the perspective view of an upward tank attached to the top according to some embodiment of the present invention.

FIG. 9 is the perspective view of a downward tank attached to the bottom according to one embodiment of the present invention.

FIG. 10A is the perspective view of a plurality of aligned rotary table systems (RTS) according to one embodiment of the present invention.

FIG. 10B is the perspective view of a plurality of aligned rotary table systems (RTS) connected to a clean energy collector (CEC) according to one embodiment of the present invention.

FIG. 10C illustrates the position of a rotary table system (RTS), a part of a soyos drop piston (SDP), according to one embodiment of the present invention.

FIG. 11A illustrates the front view of a principal capsule catcher system (CCS) attached to the top of a soyos drop piston (SDP) according to one embodiment of the present invention.

FIG. 11B illustrates the top view of a principal capsule catcher system (CCS) attached to the top of a soyos drop piston (SDP) according to one embodiment of the present invention.

FIG. 12 is an exploded view of a principal capsule tank (PCT) according to some embodiment of the present invention.

FIG. 13 is the perspective view of a secondary capsule tank (SCT) according to one embodiment of the present invention.

FIG. 14 is the perspective view of a plurality of wye filler systems (WFS) attached to the top according to one embodiment of the present invention.

FIG. 15 is the perspective view of a plurality of retracting clutch systems (RCS) according to one embodiment of the present invention.

FIG. 16A illustrates the location view of a plurality of automatic internal commands system (ICS) at the bottom of the soyos drop piston (SDP) according to some embodiment of the present invention.

FIG. 16B illustrates the location view of a plurality of automatic internal commands system (ICS) at the top of the secondary vertical travel line (VTL) according to some embodiment of the present invention.

FIG. 16C illustrates the location view of a plurality of automatic internal commands system (ICS) at the top of the principal vertical travel line (VTL) according to some embodiment of the present invention.

FIG. 17 is an exploded view of a brake-pump chamber (BPC) according to some embodiments of the present invention.

FIG. 18 is the perspective view of a Mechanical switch according to one embodiment of the present invention.

FIG. 19 is an exploded view of the main water pump (MWP) system according to some embodiments of the present invention.

FIG. 20 is a back view of a soyos environment clean engine (SECE) according to the preferred embodiment of the present invention.

### DETAILED DESCRIPTION OF THE INVENTION

The following is an alternate, exemplary description of the present invention. It is intended to further demonstrate the spirit of the present invention and various details that may be implemented in different embodiments and are not intended to limit the scope of the present invention.

The present invention is to be described in detail and is provided to establish a thorough understanding of the present invention. There may be aspects of the present invention that may be practiced or utilized without implementing some features as they are described. It should be understood that some details have not been described in detail to not unnecessarily obscure the focus of the invention. References to “the preferred embodiment,” “one embodiment,” and “some embodiments” should be considered to be illustrating aspects of the present invention that may potentially vary in some instances and should not be considered to be limiting to the scope of the present invention as a whole.

In the universe, there are many types of energy. According to the first law of thermodynamics, known as the law of conservation of energy, energy can neither be created nor destroyed, but energy changes from one form to another form of energy. The energy from burning fossil fuels like coal, petroleum, and natural gas, has been the most used during the last centuries and causing more pollution to atmospheres. We will not use energy from any burning natural resource in this present invention. We will create compressed air, hydro, and mechanical power for internal work exchange and transformation with a challenging and essential choice of carbon emission-free with the best natural resources as fuel.

In this present invention, we also take advantage of the natural physical properties of air, sand, and water (ASW) as a power source to generate clean power, a soyos environment clean engine (SECE). These natural resources are available, safe, reliable, cheap, efficient, and sustainable with atmospheric pressure and gravity for any operation in this present invention and in any place around the world. The present invention on climate change considered a top decision on choosing chemical and physical properties of these natural resources not hurting the environment: “Air-Sand-Water” (ASW).

Water is a Newtonian and essentially incompressible fluid that can build hydropower under gravitation and can be pumped with a piston. Freshwater melts at 0 deg. Celsius and the seawater with a salinity freeze around −1.8 deg. Celsius. With a boiling point of 100 degrees Celsius, the earth possesses approximately 97 percent water, making it surrounds our planet earth's best selection of soyos environment clean engine (SECE).

Sand is solid with the ability to be poured like a liquid and take the entire shape of the capsule. Sand in a small tank produces more weight than water in the same tank. 1 m3 of water weight 1,000 kg, and 1 m3 of sand weight 1,620 kg allowing less material with less weight to build the secondary capsule tank (SCT). The best solution option used to power under gravity is the opposite empty principal capsule tank (PCT) to travel back to the top initial position and minimize the loss of energy during the transfer of mechanical energy best option of soyos environment clean engine (SECE).

Air is the composition of atmospheric pressure and can be found everywhere on earth for functioning the present invention. Air has mass, can be expanded by occupying any open space exerting pressure, and can be compressed. Air is an invisible mixture of gases more compressible than water, a Newtonian fluid with more advantages that surrounds the earth with easy access and better choice of soyos environment clean engine (SECE).

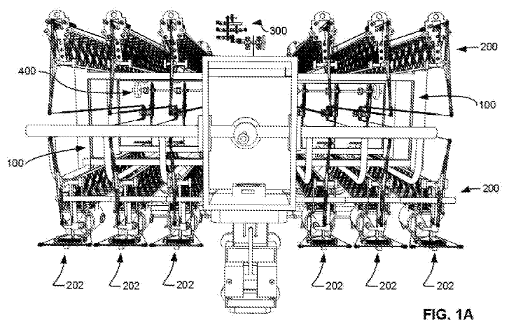

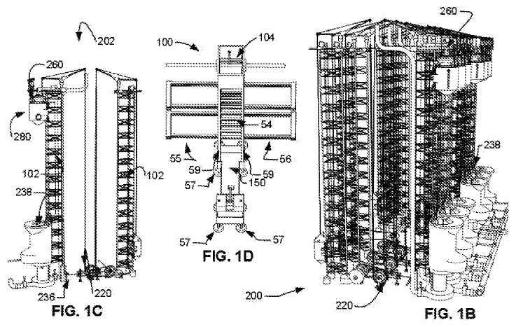

FIG. 1A illustrates a top view of an elevation of a solid upraise structure (SUS) 100 holding a clean stroke maker (CSM) system 200 according to one embodiment of the present invention. The present invention comprises at least a solid upraise structure (SUS) 100 vertically elevated may vary in height. A plurality of a clean stroke maker (CSM) system 200 wherein a plurality of soyos drop piston (SDP) 202 aligned vertically and attached to the solid upward structure 100 for continuous piston cycle; a clean energy collector 400 installed and aligned close to the soyos drop piston (SDP) 202 and coupled for continuous clean energy collection input and energy transfer output. A customized Torque-Speed builder (CTS) 300 is installed close to a clean energy collector 400 and coupled together for clean energy transmission and transformation to customized torque and speed. In this embodiment, soyos drop piston (SDP) 202 is a component of clean stroke maker (CSM) system 200 using the drop of capsules doing work like a piston to build a continuous clean stroke to the system.

FIG. 1B is an elevated view showing a clean stroke maker (CSM) 200 system according to some embodiments of the present invention; FIG. 1C illustrates a view of a single soyos drop piston (SDP) 202 according to some embodiments of the present invention; FIG. 1D is a front view showing a solid upraise structure (SUS) 100 according to some embodiments of the present invention. The present invention is a solid upraise structure (SUS) 100 vertically elevated using natural gravity force advantaging a plurality of internal work transformation for operating wherein a plurality of horizontal solid support 54 elevated, an upward tank 104 is centered and attached at the top for receiving and providing water for operation, a plurality of left wing 55 and a plurality of right wing 56 are connected in serial forming a main elongated structure size, a downward tank 150 mounted at the bottom bellow the upward tank 104 on a plurality of a strong customized footing 57 to be at the center and being a strong part of the solid upraise structure (SUS) 100, the strong customized footing 57 aligned equally and extending at the base from the ground to the top on left and right side quadrilateral wherein a solid vertical stand support 59 being attached and can be detached forming a quadrilateral elevated structure with hands to support the upward tank 104 and to receive the clean stroke maker system (CSM) 200; The clean stroke maker (CSM) system 200 comprises a plurality of soyos drop piston (SDP) 202 aligned in parallel with a cycle of production in function of the elevation, water weight and in the function of their total number. Each soyos drop piston (SDP) 202 is mounted with a rotary table system (RTS) 220; for collecting mechanical energy and transforming it into rotational energy. The soyos drop piston (SDP) 202 is configured to be customized, replacing the component's size for more power when the elevation is changed. The chain adjuster, cover, and orientation are part of the mechanical chain and wire system, allowing it to couple with the rotary table system (RTS) 220.

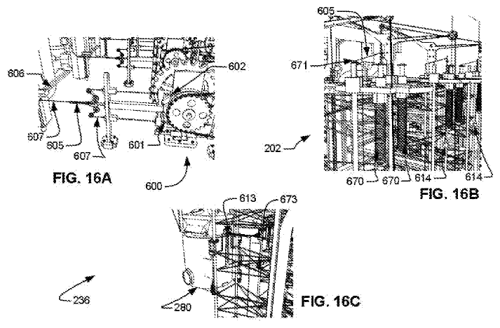

A plurality of a principal capsule catcher system (CCS) 260 attached to the top of solid upraise structure (SUS) 100 for retaining in standby, a principal capsule tank (PCT) 280 and releasing with a motion of the previous soyos drop piston (SDP) 202 for a continuing cycle. A plurality of automatic internal command system (ICS) 236 as showing in FIG. 16A-C configured to communicate with a plurality of an internal mechanical motion from a plurality of principal capsule tank (PCT) 280 travels to a plurality of switches controls 238 in serial. The plurality of soyos drop piston (SDP) 202 comprises a plurality of solid support 102 forming a triangle and vertically elevated to be strong external support of the clean stroke maker (CSM) system 200. and is also the support of the elevation of the solid upraise structure (SUS) 100 for continuous production of mechanical power.

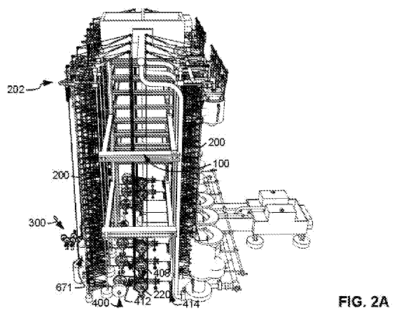

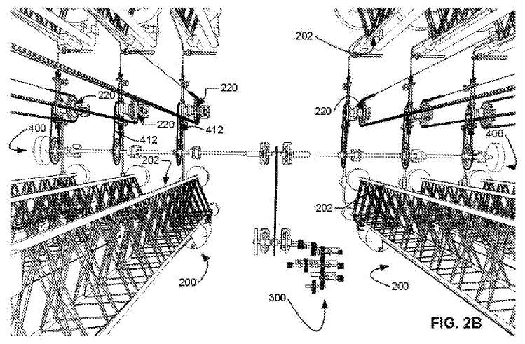

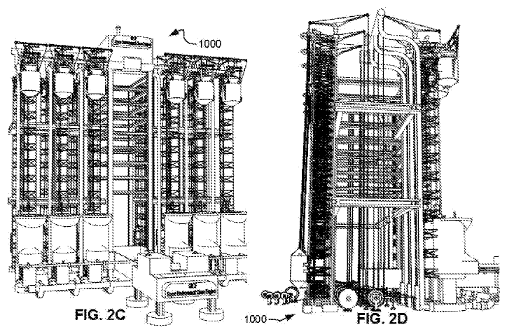

FIG. 2A is the left view of a solid upraise structure (SUS) 100 connected to a clean stroke maker (CSM) system 200 with a plurality automatic internal command system (ICS) 236 connected to a clean energy collector (CEC) 400 according to some embodiments of the present invention. The present invention comprises a plurality of soyos drop piston (SDP) 202 with a plurality of transmission chains 412 allowing sequential transmission of energy on rotary table system (RTS) 220 to a plurality of a retract clutch system (RCS) 408. The transmission chain 412 connected rotary table system (RTS) 220 to a clean energy collector (CEC) 400 to couple with a customized Torque-Speed builder (CTS) 300. A plurality of automatic internal command system (ICS) 236 as showing in FIG. 16A-C connected with a plurality of internal command lines 414 as showing in FIG. 20 allows internal works with a motion for clean energy delivery according to some embodiment of the present invention.

FIG. 2B is the elevated view of a clean energy collector (CEC) 400 positioning with a customized Torque-Speed builder (CTS) 300 according to one embodiment of the present invention. The present invention is the clean energy collector (CEC) 400, located between a rotary table system (RTS) 220 and the customized Torque-Speed builder (CTS) 300 is a mechanical system configured specially to collect continue rotational energy from the rotary table system (RTS) 220 and using the continuous shaft motion transferring clean energy to customized Torque-Speed builder (CTS) 300. According to the present invention, these embodiments are for illustrating. The sizes of solid upraise structure 100 (SUS), the size of clean stroke maker system 200 (CSM), the size of soyos drop piston (SDP) 202, the size of rotary table system (RTS) 220, the size of clean energy collector (CEC) 400, the size of the customized Torque-Speed builder (CTS) 300 may change for a various energy delivery need by the users.

FIG. 2C is a front view of a soyos environment clean engine (SECE) 1000 according to a preferred embodiment of the present invention. FIG. 2D showed a side view of a soyos environment clean engine (SECE) 1000 according to a preferred embodiment of the present invention. In some embodiments, a complete cover on the elevation to protect soyos environment clean engine (SECE) may be used with a warning signal light attached to the top for safety reasons; a chain case, chain orientation, and chain extender may be used for optimal alignment with components.

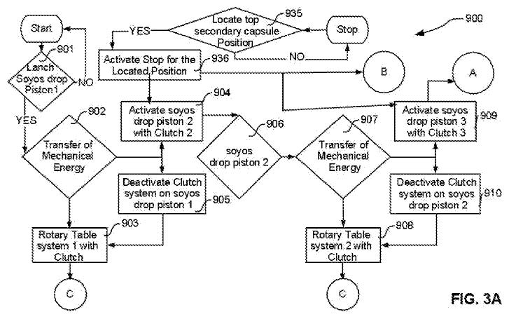

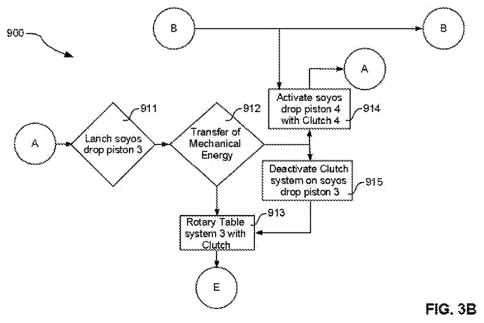

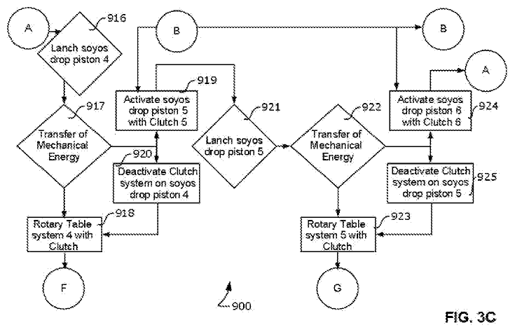

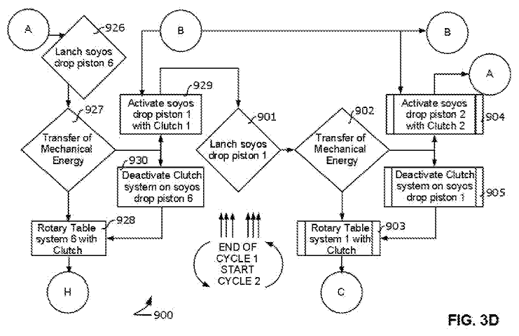

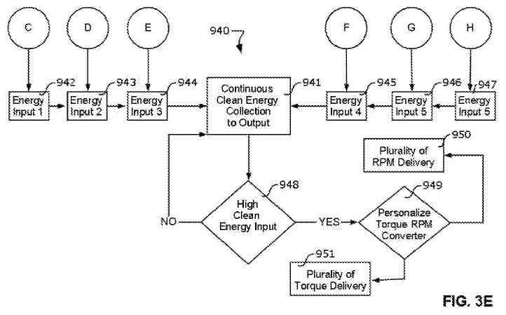

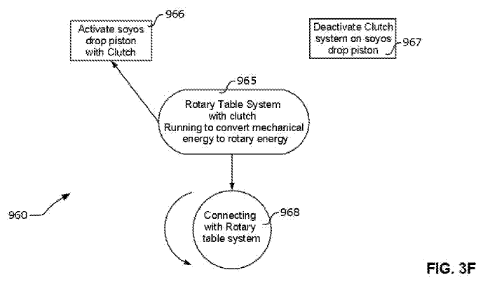

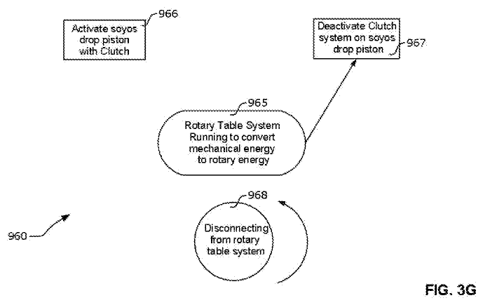

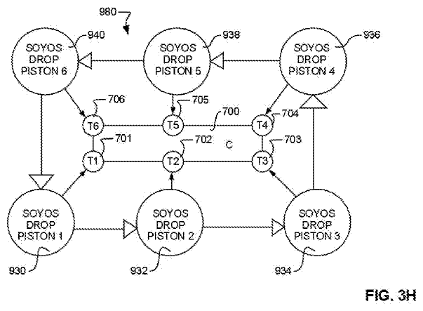

The operations method of communication: method 900, method 940, method 960, and method 980 presented below are intended to be illustrative. Some embodiments may be accomplished with one or more additional operations not described; they may be implemented in processing using a mechanical, digital, analog signal, switches devices, and/or without one or more of the operations discussed. One or more processing devices may include one or more devices executing some or all the operations of the method 900, 940, 960, and 980 may include one or more devices. Configurated through hardware, firmware, and/or software to be specifically designed to execute one or more of the operations of these methods of communication. The order in which the operations of these methods are illustrated in FIGS. 3A-H and described below is not intended to be limiting the present invention.

FIG. 3A is the flow chart illustrating a method 900, showing the steps of communication for operating a soyos environment clean engine (SECE) according to one embodiment of the present invention. FIG. 3B is a continuation of the flow chart FIG. 3A illustrates a method 900, showing the steps of communication for operating a soyos environment clean engine (SECE) according to one embodiment of the present invention. FIG. 3C is a continuation of the flow chart FIG. 3B illustrates a method 900, showing the steps of communication for operating a soyos environment clean engine (SECE) according to one embodiment of the present invention. FIG. 3D is a continuation of the flow chart FIG. 3C illustrates a method 900, showing the steps of communication for operating a soyos environment clean engine (SECE) according to one embodiment of the present invention.

At the neutral position, all principal capsule tanks (PCT) are attached and filled with water at the top in an initial position. All secondary capsule tanks (SCT) are located and filled with sand at the recommended weight at the bottom in the initial position and all main water pump (MWP) system primed with water.

When the user pushes a start engine: a message sends to an operation 901 for step 1. The message is not accurate at operation 901. A communication is sent back to the start point. The message receiving and accurate at operation 901, one principal capsule tank (PCT) on soyos drop piston is released to be the first capsule to drop starting the first cycle.

The user can stop the engine by pushing the stop button and sending a decision message at operation 935, locating the bottom position of the secondary capsule. The message is not accurate. Not finding the position of the secondary capsule tank (SCT) at operation 935, communicating back to the stop sensor from repeating the task. The message receiving is accurate at operation 935; a communication sent to activate a stop for a located position at operation 936 to stop the engine can be performed for any secondary capsule tank (SCT) located at the bottom during any decision time to stop the engine.

At operation 902, mechanical energy is transferred and transformed into rotational energy in operation 903, sending energy to be collected at C. The second message at operation 902 is sent to perform two operations simultaneously: first releasing a principal capsule tank (PCT) 2 and engaging a clutch 2 at operation 904. The second task at operation 905 sends a message disengaging clutch 1 at operation 903. To stop the engine at this step, the signal sending from operation 936 stops operation 904. At operation 906, principal capsule tank (PCT) 2 is released with clutch 2 as part of a soyos drop piston 2. At operation 907, mechanical energy is transferred and transformed into rotational energy at operation 908, sending energy to be collected at D. The second message at operation 907 is sent to perform two operations at the same time: the first task at operation 909 is releasing a principal capsule tank (PCT) 3 and engaging clutch 3 going to A for continuous operation, the second task at operation 910 sending a message disengaging the clutch 2 at operation 908. To stop the engine at this step, the signal sending from operation 936 continues to B, stopping operation 909. The flow chart in FIG. 3A is the perfect example illustrating and showing these steps. The continuation message A at operation 911 releases a principal capsule tank (PCT) 3 with a clutch 3 as part of a soyos drop piston 3.

At operation 912, mechanical energy is transferred and transformed into rotational energy at operation 913, sending energy to be collected at E. The second message at operation 912 is sent to perform two operations at the same time: the first task at operation 914 is releasing a principal capsule tank (PCT) 4 and engaging clutch 4 going to A for continuous operation, and the second task at operation 915 sending a message disengaging the clutch 3 at operation 913. To stop the engine at this step, the signal sending from operation 936 continues to B, stopping operation 914. The flow chart in FIG. 3B is the perfect example illustrating and showing these steps. The continuation message A at operation 916 releases a principal capsule tank (PCT) 4 with a clutch 4 as part of a soyos drop piston 4.

At operation 917, mechanical energy is transferred and transformed to rotational energy at operation 918, sending energy to be collected at F. The second message at operation 917 is sent to perform two operations at the same time: the first task at operation 919 is releasing a principal capsule tank (PCT) 5 and engaging clutch 5 going to A for continuous operation, and the second task at operation 920 sending a message disengaging the clutch 4 at operation 918. To stop the engine at this step, the signal sending from operation 936 continues to B, stopping operation 919. At operation 921, releasing a principal capsule tank (PCT) 5 with a clutch 5 as part of a soyos drop piston 5.

At operation 922, mechanical energy is transferred and transformed to rotational energy in operation 923, sending energy to be collected at G. The second message at operation 922 is sent to perform two operations at the same time: the first task at operation 924 is releasing a principal capsule tank (PCT) 6 and engaging clutch 6 going to A for continuous operation, the second task at operation 925 sending a message disengaging the clutch 5 at operation 923. To stop the engine at this step, the signal sending from operation 936 continues to B, stopping operation 924. The flow chart in FIG. 3C is the perfect example illustrating and showing these steps.

At operation 926, a last principal capsule tank (PCT) 6 with a clutch 6 as part of a soyos drop piston 6 releasing to complete the first cycle. At operation 927, mechanical energy is transferred and transformed into rotational energy at operation 928, sending power to be collected at H. The second message at operation 927 is sent to perform two functions at the same time: the first task at operation 929 is releasing a principal capsule tank (PCT) 1 and engaging clutch 1 going to A to start a second cycle for continuous operation, the second task at operation 930 sending a message disengaging a clutch 6 at operation 928.

According to the present invention, communications operations may be performed by a module using a programmed switch with different signal sensors controlled to start/end sequences, and the one cycle timing depend on the Height of the upward structure and the Weight of the capsule to perform internal work and energy produced. To stop the engine at this step, the signal from operation 936 continues to B, stopping operation 929 and ending the first cycle of the clean stroke maker. The flow chart in FIG. 3D is the perfect example of illustrating and showing these steps. Soyos environment clean engine (SECE) is configurated with a module allowing to adjust the height, weight, and size to have different amounts of clean, sustainable, and accessible energy.

FIG. 3E is the flow chart illustrating a method 940, showing the steps of communication for operating a clean energy collector (CEC) according to some embodiments of the present invention. The input rotational energy to the clean energy collector (CEC) arriving in the continuing sequence depends on the time the principal capsule tank (PCT) travels, delivering mechanical energy. This time is a function of elevation of the upward structure and the Weight of the capsules: the more the structure is highest, one sequence can take more time before switching to the second sequence of input. At Operation 942, a sequence 1, rotational energy from C sends a message to operation 941. A sequence 2 automatically delivers at operation 943, receiving rotational energy from D and sending it to operation 941. This same step of the operation is repeated in sequence 3 with operation 944 receiving rotational energy from E and sending a message to operation 941, in sequence 4 with operation 945 receiving rotational energy from F and sending a message to operation 941, in sequence 5 with operation 946 receiving rotational energy from G and sending a message to operation 941, and at sequence 6 with operation 947 receiving rotational energy from H and sending a message to operation 941. At operation 941, a continuous clean energy collecting and delivery to operation 948. Operation 948 sends back a message to operation 941 to optimize continuous clean energy collection for less clean energy input. At operation 948, receiving high clean energy from operation 961, converting and sending to operation 949 for final conversion, and sending a message at operation 950 delivering a plurality of rpm for different external work to the user. Operation 949 for final conversion also sends a message at operation 951, providing a plurality of torque for other exterior work to the user. The flow chart in FIG. 3E is the perfect example illustrating and showing these steps.

FIG. 3F is the flow chart illustrating a method 960, showing the steps of communication activating a clutch on a rotary table system (RTS) according to some embodiments of the present invention. FIG. 3G is the flow chart illustrating a method 960, showing the steps of deactivating a clutch on a rotary table system (RTS) according to some embodiments of the present invention. Operation 965 may be performed by receiving two messages separately: in step 1 the operation 966 sends the first message of motion pulling the activator to start a clutch on the rotary table system (RTS) running and converting mechanical energy to rotary energy at operation 965, connecting operation 968 transferring the rotational energy to clean energy collector (CEC) the end of the stroke is equivalent ending step 1 and the step 2 starting automatically. In step 2, operation 967 sent a message of motion to deactivate the clutch on the rotary table system (RTS) at operation 965 and at operation 968, allowing free rotation on operations 965 and 968.

FIG. 3H to illustrate a cycle timeline schematic 980 showing the internal communication of a complete one cycle operating a clean stroke maker system (CSM) according to some embodiments of the present invention. The total time of one cycle at schematic 980 is a total timing performed with the number of each soyos drop piston.

At step 1, operation 930 performed a task communicating with timing 701, delivering mechanical energy for internal work exchange and interest to a user. At the end of step 1, the next step is automatically starting.

In step 2, operation 932 performed a task communicating with timing 702, delivering mechanical energy for internal work exchange and interest to a user. At the end of step 2, the next step is automatically starting.

At step 3, operation 934 performed a task communicating with timing 703, delivering mechanical energy for internal work exchange and interest to a user. At the end of step 3, the next step is automatically starting.

At step 4, operation 936 performed a task communicating with timing 704, delivering mechanical energy for internal work exchange and interest to a user. At the end of step 4, the next step is automatically starting.

At step 5, operation 938 performed a task communicating with timing 705, delivering mechanical energy for internal work exchange and interest to a user. At the end of step 5, the next step is automatically starting.

At step 6, operation 940 performed a task communicating with timing 706, delivering mechanical energy for internal work exchange and interest to a user. At the end of step 6, the next step is automatically starting.

In step 7, the total timing communicated for one cycle at operation 700 is summed up of timing 701, plus timing 702, plus timing 703, plus timing 704, plus timing 705, and timing 706.

According to this present invention, some embodiment can complete a cycle with a method using: two, three, four, five, six, seven, eight, nine, ten, twelve soyos drop piston (SDP) or with a method of a plurality of soyos drop piston (SDP) to make one complete clean stroke cycle the example illustrated in this present invention utilize a method of six soyos drop piston (SDP) to complete one cycle.

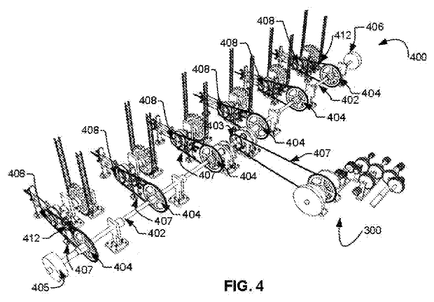

FIG. 4 is the perspective view of a clean energy collector (CEC) connected to a customized Torque-Speed builder (CTS) according to some embodiment of the present invention. The present invention consists of the clean energy collector (CEC) 400 comprising a main shaft 402 wherein a main sprocket 403 is mounted at the center. A plurality of input sprocket 404 is horizontally aligned on both sides of the main sprocket 403 with a left flywheel 405 and a right flywheel 406. The sprocket is connected with a chain 407 to a plurality of retracting clutch system (RCS) 408 of the driving sprout teeth. The main sprocket 403 is coupled with chain 407 to the driven sprocket of a customized Torque-Speed builder (CTS) 300 for clean energy transmission. A chain case and chain orientation may be used for alignment and protection in some embodiments.

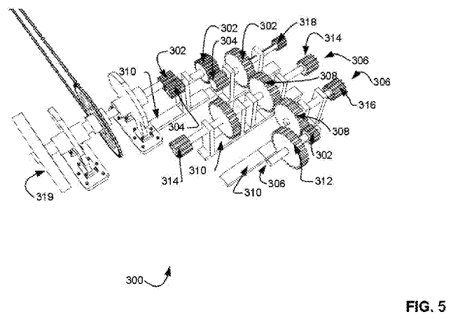

FIG. 5 is a top view of the customized Torque-Speed builder (CTS) 300 according to one embodiment of the present invention wherein a plurality of driving gear 302 are connected to a plurality of driver gear 304 to transform the clean energy input capacity to different work. By providing a plurality of higher or lower output torque and rpm for the customized need of the user, examples of centralized and decentralized electrical generation plants, industrial electric power generation, factories electric motor power plants. The plurality of compound gear 306 connected to a plurality of idle gear 308 for internal force and speed transformation and a plurality of gear ratio adjuster 310 installed to allow different clean engine work delivery for high torque shaft delivery 312, for low torque shaft delivery 314, for high rpm shaft delivery 316, for low rpm shaft delivery 318. The flywheel 319 is being mounted in the customized Torque-Speed builder (CTS) 300 to keep an optimal performance delivery with the capacity of the capsules. All the mechanisms are connected to forming an adjusted system for removing and installing different new sizes of gears at the stop for customizing the working engine capacity needed by the user for different mechanical energy inputs recommended for different types of machines available on the market.

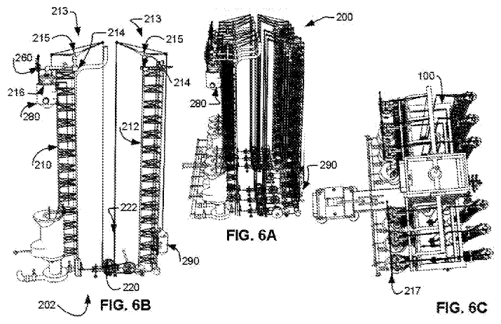

FIG. 6A illustrates a view of a clean stroke maker (CSM) system according to some embodiments of the present invention, FIG. 6B shows an example of one soyos drop piston (SDP) 202 according to some embodiments of the present invention; FIG. 6C illustrates a top view showing an example of a solid upward structure (SUS) 100 according to some embodiments of the present invention. The present invention consists of the clean stroke maker (CSM) system 200 being the effect of producing a continuous stroke that will generate continuous clean energy and do the different internal works with zero carbon emission. To achieve this: a plurality of soyos drop piston (SDP) 202 gives a continuous cycle of force as no pollution piston transformed to energy combined with the natural presence of gravity and atmospheric pressure. The three natural elements combined: air, sand, and water (ASW) with the advantage of their physical and chemical properties in the capsules and chambers to make this present invention helpful and easy to work everywhere on earth as needed. The composition of each soyos drop piston (SDP) 202 comprises the principal vertical travel line (VTL) 210 and the secondary vertical travel line (VTL) 212, both elevated and aligned, forming the elevated base support with the solid upward structure (SUS) 100 for the entire elevated support of the present invention and connected with a solid power transmission long chain wire drive 222 to the rotary table system (RTS) 220. The principal capsule catcher system (CCS) 260 is on top of the principal vertical travel line (VTL) 210. The head angle extender system 213 is mounted at the top of the principal vertical travel line (VTL) 210 and the secondary vertical travel line (VTL) 212. The head angle extender system 213 comprises a main solid support 214 attached to the principal vertical travel line (VTL) 210 and also attached to the secondary vertical travel line (VTL) 212. Keeping in position and supporting the angle adjuster bloc 215 and the capsule hand holder 216, allowing the hand customized angle 217 for changing positions. The head angle extender system 213 is configured to give angle alignment orientation changing in size of the principal capsule tank (PCT) 280 and the secondary capsule tank (SCT) 290, and the rotary table system (RTS) 220. The angle adjuster block 215 is mounted on the main solid support 214 for solid support.

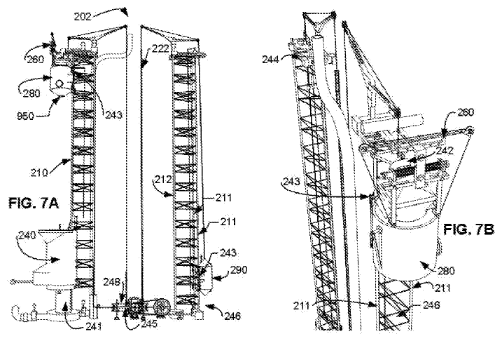

FIG. 7A illustrates a front view of a soyos drop piston (SDP) 202 showing the components according to some embodiments of the present invention; FIG. 7B illustrates a top view of a soyos drop piston (SDP) 202 showing the details according to some embodiments of the present invention. The present invention, including the principal vertical travel line (VTL) 210, is the first elevated component of the soyos drop piston (SDP) 202, wherein a solid bar 211 is mounted vertically, the brake-pump chamber (BPC) 240 attached to the top of the main water pump (MWP) system 241. Both are located at the bottom of the principal vertical travel line (VTL) 210, the wye filler system 242, and the principal capsule catcher system (CCS) 260 are installed on top proximate to the final principal capsule tank (PCT) 280 position. The principal capsule tank 280 is attached to the two vertical solid bar 246 with wheel system 243 mounted on the principal vertical travel line (VTL) 210. The secondary capsule tank 290 is at the opposite position of the principal capsule tank 280 and attached to two solid bar 211 with wheel system 243, both mounted on secondary vertical travel line (VTL) 212 to be aligned vertically with the principal vertical travel line (VTL) 210. The spring absorber brake 244 is attached to the top and aligned to receive the secondary capsule tank (SCT) 290 and stop the mechanical movement from the bottom to the top. The retract clutch mechanical control 245 is configured to pull the solid control bar 248. The secondary capsule tank (SCT) 290 is attached on two vertical solid bars 246 with a plurality of wheel system 243. And to travel at the opposite position of the principal capsule tank (PCT) 280 and connected with a solid power transmission long chain wire drive 222 to form a single soyos drop piston (SDP) 202.

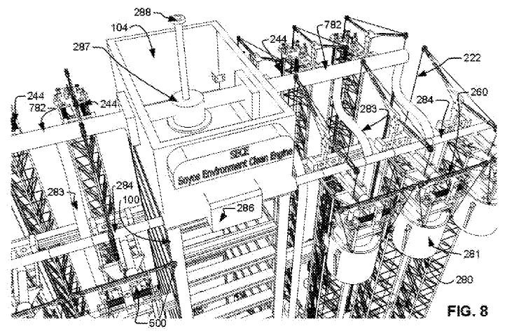

FIG. 8 is the perspective view of an upward tank 104 attached to the top according to some embodiment of the present invention. The present invention, including the upward tank 104 attached to the top of the solid upraise structure (SUS) 100, is mounted with a mechanism configurated to be mechanically opened and closed. The mechanical system allows to fill with the principal capsule tank (PCT) 280 with water increasing the total weight to achieve an exploded mechanical energy for the present invention. When the capsule is released from the principal capsule catcher system (CCS) 260 traveling from the top to the bottom, a large amount of mechanical energy is released to be able to compensate for the total energy produced from the opposite secondary capsule tank (SCT) 290 as showing in FIG. 7A wherein a total weight of sand plus a total empty weight of secondary capsule tank (SCT) 290 plus all friction of the system and opposite force all together forming a mechanical resistant forming a system 1. according to this present invention to be always less than the total weight of the mechanical energy produces by the principal capsule tank (PCT) 280, plus a total weight of the water inside forming a system 2. As system 1 is inferior to system 2, the system is configured to obtain an additional large amount of energy filled in the principal capsule tank (PCT) 280, which is more important for this present invention and used for generating clean energy for the system. The principal capsule tank (PCT) 280 comprises a tank body 281 located at the center to carry the amount of water necessary for optimal operation. The fill-up manifold 782, located proximate to the top of the upward tank 104, is connected to a plurality of water pumps discharge pipe 283 coming from a discharge of a plurality of main water pump (MWP) system 241 shown in FIG. 7A; The discharge manifold 284 is configured to be full of water with large size to create more hydro energy for quick capsule filling and is located at the bottom of the upward tank 104. A plurality of wye filler system 500 is located at the top of the principal capsule tank (PCT) 280 and connected to the discharge manifold 284. The bottom booster tank 286, located at the bottom and at the center of the upward tank 104, is lined up with discharge manifold 284 to boost the hydro energy needed to fill the principal capsule tank (PCT) 280. The drop control case 287 was installed on top and at the center of the upward tank 104 to control the arrival of water in the upward tank 104. The air control 288 is connected to the drop control case 287 to control the water pressure arrival in the upward tank 104.

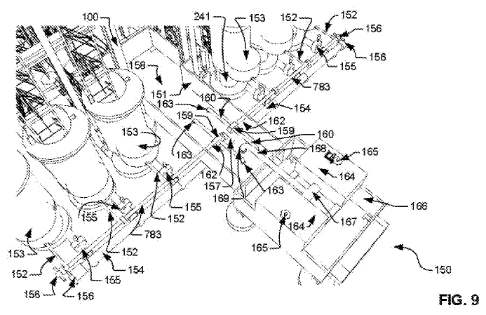

FIG. 9 is the perspective view of a downward tank 150 attached to the bottom according to one embodiment of the present invention. The present invention includes the downward tank 150 attached at the bottom of the solid upraise structure (SUS) 100 to collect water and supply the main water pump (MWP) system 241. comprises the tank body 151, wherein the right side of the fill-up manifold 783 located at the top of the downward tank 150 is connected to a plurality of drop control pipe 152 mounted to a plurality of drop containment tank 153, ending with the maintenance access system 156. The left side of the fill-up manifold 783, located at the top of the downward tank 150, is connected to a plurality of drop control pipe 152 mounted to a plurality of drop containment tank 153, ending with the maintenance access system 156. The discharge manifold 154 is mounted at the bottom of the tank for supplying water to the main water pump (MWP) system 241 connected to a plurality of water pulling control 155 for air and water control. Maintenance access system 156 was installed at the end of both sides for maintenance and cleaning of the inside for smooth water delivery. The bottom booster tank 157 is installed and opened inside the bottom center of the main tank 158 and connected to the left and right discharge manifold 154 pipes. The drop control pipe 159 is located at the center on top of the downward tank 150, wherein the left and right main pipe 160 are both oriented to the bottom of the downward tank 150. A plurality of drop reservoir discharge 162 connected to the left and to the right of the two ways drop pipe 163 oriented to the bottom on both sides of the downward tank 150 and horizontally attached to the left and right main pipe 160. The right antifreeze reservoir tank 164 with closure cap 165 configurated with thermostat and electric valve actuator checking on ambient temperature to open the valve 169 to automatically fill the downward tank 150 with antifreeze. A left antifreeze reservoir tank 164 with closure cap 165 is configurated internally with an open equalizing level pipe. Reservoirs were installed on top of the tank body 166 and connected at the bottom with an extended communication pipe 167. The discharge pipe 168 is installed in the middle of the communication pipe 167. and on the opposite side-mounted with one valve 169 oriented on the bottom of the downward tank 150.

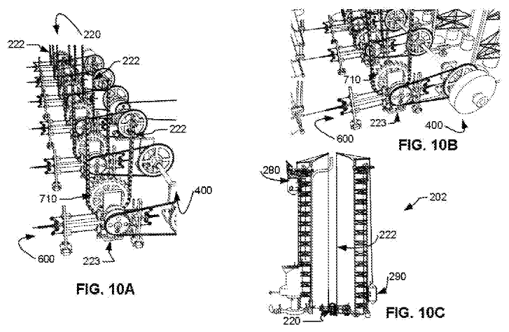

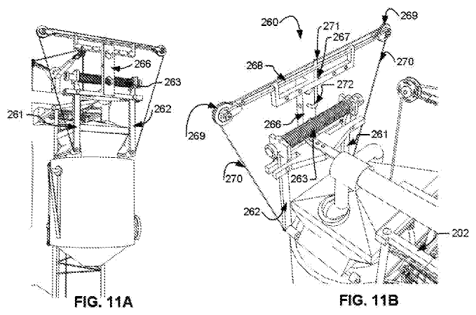

FIG. 10A is the perspective view of a plurality of aligned rotary table systems (RTS) 220 according to one embodiment of the present invention, FIG. 10B is the perspective view of a plurality of aligned rotary table systems (RTS) 220 connected to a clean energy collector (CEC) 400 according to one embodiment of the present invention and FIG. 10C illustrates the position of a rotary table system (RTS) 220, a part of a soyos drop piston (SDP) 202, according to one embodiment of the present invention. The present invention consists of a plurality of the rotary table system (RTS) 220 aligned to form the bottom of the soyos drop piston (SDP) 202. Each soyos drop piston (SDP) 202 comprises a strong drive central sprocket 710 configurated to be installed and replaced to carry the different sizes of principal capsule tank (PCT) 280. Mounted with a wire bearing installed at the center to carry the mechanical wire cable as optional. A retract clutch system (RCS) 600 is installed with the rotary table system (RTS) 220, communicating with the internal command engaging and disengaging the rotary table system (RTS) 220 to the clean energy collector (CEC) 400. The system is attached to a plurality of solid support 223 to be detached to increase the size to increase the clean energy output and decrease the size to decrease the clean energy output. The strong drive central sprocket 710 is at the center and aligned with the two solid elevated bars on each side and connected with the principal capsule tank (PCT) 280 on one side and in the opposite position with the secondary capsule tank (SCT) 290. The rotary table system (RTS) 220 is connected to both capsules with a solid power transmission long chain wire drive 222 traversing the strong drive central sprocket 710 producing rotational energy.

FIG. 11A illustrates the front view of a principal capsule catcher system (CCS) 260 attached at the top of a soyos drop piston (SDP) 202 according to one embodiment of the present invention, FIG. 11B illustrates the top view of a principal capsule catcher system (CCS) 260 attached at the top of a soyos drop piston (SDP) 202 according to one embodiment of the present invention. The present invention includes the principal capsule catcher system (CCS) 260 comprising the left arm with finger 261 and the right arm with finger 262. A spring stabilizer 263 is installed between both arms to open and retain the capsule with the movement. A solid extend bar 266 is elevated on top of the spring stabilizer 263 extended with the mechanical wire support 267 attached to the solid extend bar 268. Left and right swivel pulley 269 attached to the left and right to the solid extend bar 268 for free movement and the optimal force needed to operate the mechanism. A strong mechanical wire 270 is attached to the bottom of the left arm with finger 261 and the right arm with finger 262 to allow the support to move to hold and release the principal capsule tank (PCT). The mechanical wire pipe 271 juxtaposed the bottom of both left and right mechanical wire 270 passing through one mechanical wire pipe 272 going to automatic mechanical internal 236 commands as showing in FIG. 16A-C to operate the system.

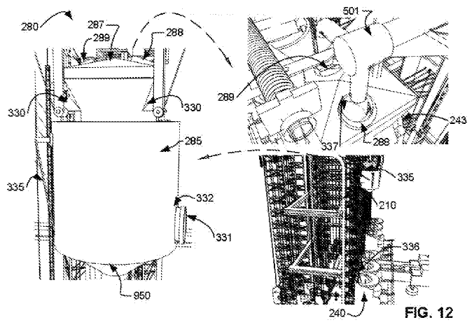

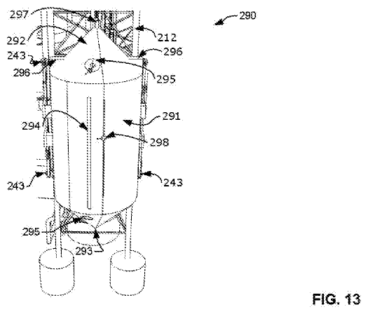

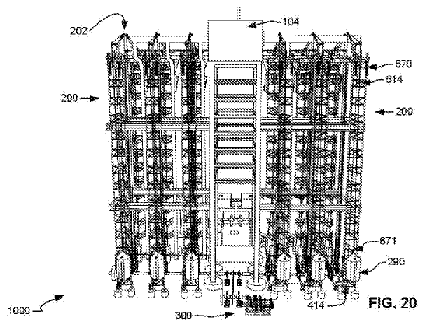

FIG. 12 is an exploded view of a principal capsule tank (PCT) 280 according to some embodiment of the present invention. The present invention includes the principal capsule tank (PCT) 280 comprising a main tank 285 to hold the water, a cone-shaped 286 on the bottom is a strong part of the principal capsule tank (PCT) 280 to be seated at the final stop on a cone-shaped seat 997 as showing in FIG. 19 to optimize the movement of the water piston rod and stopping safely the principal capsule tank (PCT) 280 protecting the water pump system (WPS), a square pyramid 287 with principal filling hole 288, and a secondary filling hole 289 configured on top to fill the principal capsule tank (PCT) 280 and to minimize the air resistance for travelling back to the top initial position; the bottom of the square pyramid 287 is mounted with the left and right retainer seat 330, a quick drop valve 331 mounted at the bottom of the main tank 285 wherein a disc with a spring forming a seal 332 is attached, an extender opener 335 mounted to be aligned with solid tube actuator 336 on a brake-pump chamber (BPC) 240, a floater 337 mounted inside of the main tank 285 to close the principal filling hole 288, and a secondary filling hole 289 to avoid water drop during the travel and to control the filling with the main one-way valve 501, as filler head located on top of the main tank 285 and aligned with the two filling hole, the principal capsule tank (PCT) 280 is mounted on the principal vertical travel line (VTL) 210 with left and right wheel system 243.

FIG. 13 is the perspective view of a secondary capsule tank (SCT) 290 according to one embodiment of the present invention. The present invention includes the secondary capsule tank 290 comprising a body cylinder 291 to carry the sand filled with the amount needed to travel back to the top position of the principal capsule tank (PCT). The top cone 292, a bottom cone 293 are mounted to minimize air resistance during travel and for optimal energy to deliver to the system. A level meter 294 is installed to indicate the sand load inside the body cylinder 291. A Load/offload door 295 is mounted at the top and bottom to fill and remove the sand inside the secondary capsule tank (SCT) 290. A Spring absorber seat 296 is mounted at the top and aligned with the spring absorber at the top. A Chain Cable attaches 297, mounted at the top of the top cone to be connected with the wire chain. A sand retainer 298 is installed inside the body cylinder 291 with the tide mechanism to immobilize the sand that travels. The secondary capsule tank (SCT) 290 is mounted on a secondary vertical travel line (VTL) 212 with left and right wheel system 243 configurated in the opposite travel direction of the principal capsule tank (PCT).

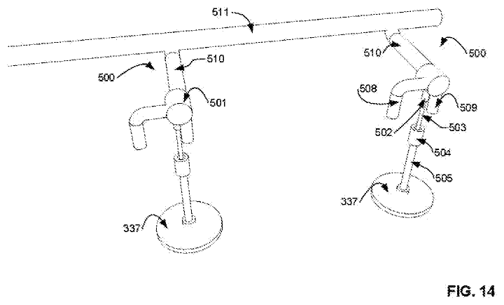

FIG. 14 is the perspective view of a plurality of wye filler system (WFS) 500 attached to the top according to one embodiment of the present invention. The present invention consists of a plurality of wye filler systems (WFS) 500 each of the wye filler systems (WFS) 500 comprises a least one main one-way valve 501 wherein: a disc-spring extender 502, with setting orientation 503, aligned with a capsule floater housing seat 504. The main one-way valve 501 is configured to control the water entry into the principal capsule tank (PCT), opening the valve with the arrival force of the capsule to the top position and closing with the upward force exerted by the water on the capsule floater 337. The setting tool orientation 503 provided force to open the disc of one-way valve 501 to allow water to fill the capsule, the water level tube extender floater 505, connected to the floater 337 mounted inside and travel with the principal capsule tank (PCT). The upward force of the water level on the floater 337 inside the principal capsule tank (PCT) operates the main one-way valve 501. The capsule floater housing seat 504 is moved up with the amount of water filling in the capsule and configured to push the disc-spring extender 502 at the full filling level of the capsule to reset the valve at a close position to stop the water. The left discharge pipe 508 and the right discharge pipe 509 are configured for quick water filling and extended to be aligned with the principal filling hole 288 and a secondary filling hole 289, as shown in FIG. 12. The main pipe 510 is configured to supply a large amount of water in seconds and connected to the one-way valve 501 on one side and to upward tank discharge manifold line 511 in the opposite direction.

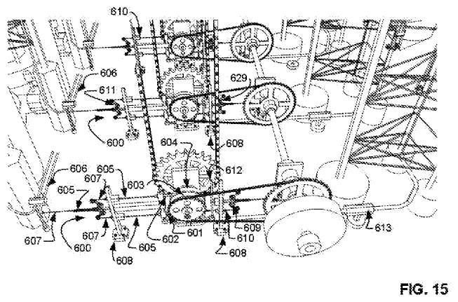

FIG. 15 is the perspective view of a plurality of retracting clutch system (RCS) 600 according to some embodiment of the present invention. The present invention consists of a plurality of retracting clutch system (RCS) 600 configured to disengage with a pulling mechanical cable system, each comprising: a lower pyramidal long tube 601; an upper pyramidal long tube 602, both installed between a flexible disc 603 and a solid disc 604; with a mechanical cable 607 passing inside mechanical cable pipe 605. A right solid support 608, left solid support 608 holds the mechanism in place, a right cable pulley system 609, and a left cable pulley system 611, allowing the mechanical cable with the optimal force for a retract and extender control 610. the lower pyramidal long tube 601 and the upper pyramidal long tube 602 are mounted horizontally proximate to the center and located between the flexible disc 603 and the solid disc 604. The left solid support and the right solid support 608 are configured to support and carry the mechanical cable pipe 605 orientation. A pyramidal long tube retainer 612 is installed between the right solid support 608 and the solid disc 604 on the right side. Two mechanical cables 607 connect both ends of upper pyramidal long tube 602 and lower pyramidal long tube 601, traversing the right cable pulley system 609 system to the mechanical cable 607 to be elongated and connected to the retract clutch take off mechanical control 613. On the left side, two mechanical cables 607 connected both ends of upper pyramidal long tube 602 and lower pyramidal long tube 601, traversing the left cable pulley system 611 system to the mechanical cable pipe 605 extending to be connected to the mechanical switch line 606 installed at the top of the capsule brake entry.

FIG. 16A illustrates the location view of a plurality of automatic internal command system (ICS) 236 at the bottom of soyos drop piston (SDP) according to some embodiment of the present invention; FIG. 16B illustrates the location view of a plurality of automatic internal commands system (ICS) 236 at the top of the secondary vertical travel line (VTL) according to some embodiment of the present invention; FIG. 16C illustrates the location view of a plurality of automatic internal commands system (ICS) 236 at the top of the principal vertical travel line (VTL) according to some embodiment of the present invention. A plurality of automatic internal command system (ICS) 236 according to some embodiment of the present invention comprising: a plurality of spring absorber 670 located on top to brake the secondary capsule and to control the force to push a solid tube 614 allowing a mechanical cable 607 to deactivate the upper pyramidal long tube 602 and lower pyramidal long tube 601 to disengage the clutch system from rotary table system (RTS), a plurality of bearing 673 is mounted on the system to facilitate a free movement of a mechanical cable 607; passing into a plurality of mechanical cable pipe 605 for optimal mechanical motion internally need to control the system to do the works, a cable pulley system 671 configured to be connected the plurality of soyos drop piston (SDP) 202 internally, engaged and disengaged a plurality of retracting clutch system (RCS) 600, releasing a plurality of principal capsule tank (PCT) 280, to open and close water in the upward tank. automatic internal command system (ICS) 236.

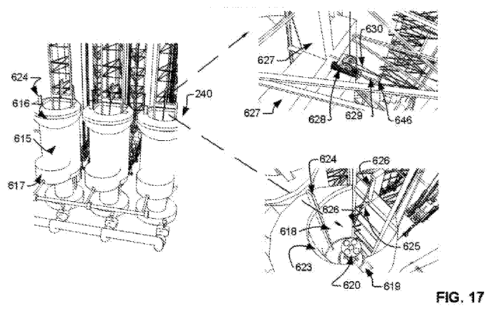

FIG. 17 is an exploded view of a brake-pump chamber (BPC) 240 according to some embodiments of the present invention. The present invention consists of a plurality of brake-pump chamber (BPC) 240 attached at the bottom of the principal vertical rail. Each brake-pump chamber (BPC) 240 comprises at least one main chamber 615; one cap 616 mounted at the top; one drop containment tank 617 attached to the bottom. A capsule brake entry 618 configured to the shape of the principal capsule tank (PCT) 280. A principal capsule drop valve housing 619 oriented from top to bottom receiving the capsule to create air force to pump and stop the capsule. A large head flat pump rod 620 extended inside the main chamber 615, allowing push and pull power to pump and suck water. A left spring absorbers head 621 and a right spring absorbers head 622, as shown in FIG. 19 installed at the bottom of the main chamber 615; a water control 623 connected to drop containment tank 617; at least one solid tube actuator 624 installed on the cap and oriented vertically from top to bottom. A mechanical switch 625 is installed at the top of the capsule brake entry 618, wherein a long flat tube 626 is installed on a solid support 627 forming a reverse Tee. An extension spring 628 to extend and retract the solid tube 629 traverses the solid support 627 to connect with the center of the long flat tube 626, the opposite end forming a tee, and the two control cables long flat tube 630 is connected.

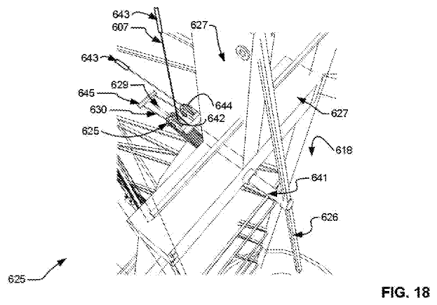

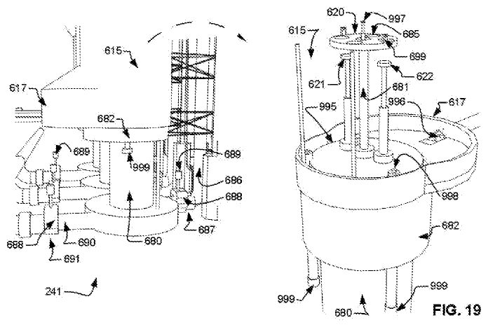

FIG. 18 is the perspective view of a mechanical switch 625 according to some embodiment of the present invention. The present invention, including the mechanical switch 625 installed at the top of the capsule brake chamber entry 618, comprises: a long flat tube 626 being installed to an extended support 641 on a solid support 627 forming a reverse Tee; a mechanical cable 607 connected the long flat tube 626 with one pulley system 642 oriented to the tube line 643 to the second principal capsule tank retainer 260 as showing in FIG. 11, the second pulley 644 is oriented to the tube line 643 to the second retract clutch system (RCS) 600, as shown in FIG. 10A; Extending pulling/pushing the bar on spring 645 is installed on the solid tube 629 extended in tee between the top two cable line 630. The extended tube connected to the long flat tube 626 is configured to allow the principal capsule tank (PCT) 280, as shown in FIG. 7, to be touched to push the mechanism during the entry. Two works are provided simultaneously during the movement, one to release principal capsule tank (PCT) 280, as shown in FIG. 7, and the second is to engage the clutch of the second soyos drop piston (SDP).

FIG. 19 is an exploded view of the main water pump (MWP) system 241 according to some embodiments of the present invention. The present invention includes a plurality of main water pump (MWP) system 241 wherein each comprising: a large water cylinder pump 680 with a strong cover 682 mounted at the bottom to the center of a drop containment tank 617; a long piston rod 681 extended in the main chamber 615 ended with a large head flat pump rod 620 wherein a plurality of air push hole 685 are installed at the top, the strong cover 682 formed an inclined surface 995 to allow water to be drained into the drain hole 996 of the containment tank 617 inside the main chamber 615; a left absorber head 621 and a right absorber head 622 are mounted at the top to receive the bottom of the large head flat pump rod 620 to be seated to allow the cone-shaped 950 of the principal capsule tank (PCT) 280 as showing in FIG. 7A to seat and stop with absorption force on the cone-shaped seat 997. A discharge line 686 from bottom to top comprises elevated water pumping control 687 installed at the bottom, wherein one-way valve 688 is mounted with a control air system 689 to keep the fluid inside the elevated pipe column to avoid priming. The hydrostatic pressure inside the column is inferior to the force created by air and the weight of the capsule inside the brake pump chamber (BPC). To allow efficient pumping with the air force pushing down the large head flat pump rod 620. And moving to his final position with the weight of the principal capsule tank (PCT) 280. The water is moving into the top tank. A fill line 690 comprises water pulling control 691 wherein one-way valve 688 is mounted with a control air system 689 to suck water into the large water cylinder pump 680 and control air built-in for optimal piston discharge. A plurality of exhaust air system 999, each configured with an exhaust air control 998 to regulate and to allow the large head flat pump rod 620 and air push hole 685 in the main chamber 615 to be pushed down, creating a force to pump the water into the main water pump (MWP) system 241 to the upward tank 104 as showing in FIG. 8 to pump back the amount of water displaced to create the work, and the second role is to exhaust additional extra air force out of the brake-pump chamber (BPC) 240, as shown in FIG. 17. The mechanical force needed to pull the large head flat pump rod 620 to fill the large water cylinder pump 680 is also included in the weight of the sand fill in the secondary capsule tank (SCT) 290, as shown in FIG. 13. This force is balanced when the principal capsule tank (PCT) is empty. The secondary capsule tank (SCT) 290 is pre-filled with the amount of sand to be superior to the weight of the empty principal capsule tank (PCT) 280. Plus, the weight to pull the large head flat pump rod 620 connected with wire to the pulling connection head 699 and the weight to allow adjustment time for the standard timing configurated to be identical at each secondary capsule tank (SCT) 290 for a complete cycle. This pulling force allows the mechanical wire cable from the bottom to the top connected to the mechanical push head actuator to pull the water into the pump cylinder barrel, ready for the next cycle.

FIG. 20 is a back view of a soyos environment clean engine (SECE) 1000 according to the preferred embodiment of the present invention showing the back elevation with stroke maker (CSM) system 200 elevated on both side, secondary capsule tank (SCT) 290, soyos drop piston (SDP) 202, customized Torque-Speed builder (CTS) 300, internal command lines 414, upward tank 104, solid tube needle actuator 671 installed on the secondary capsule tank (SCT) 290 being aligned to control and to push a solid tube 614 at the top to disengage the clutch.

The present invention is the production of clean energy. The present invention is the production of sustainable energy. The present invention produces accessible energy increasing electricity availability with less cost. The present invention is an innovative and complex choice combining natural resources available with no pollution. It is the best fit for our environment with zero carbon emission and without compromising the ability of future generations as a power source. The present invention is a method for internal communication producing clean, sustainable, and accessible energy, a soyos environment clean engine (SECE). For the present disclosure, a system and method for producing clean, sustainable, accessible energy with “Air-Sand-Water” (ASW) as a power source to create compressed air energy, hydro energy, mechanical energy for internal work exchange, and clean power delivery. A soyos environment clean engine (SECE) aims to improve energy production technology, using water weight in a specific configurated upward structure with the advantage of gravity to create mechanical energy. This energy produced is converted to rotary energy for the interest to be transformed to clean energy and create compressed air energy at the end of the translation movement of the capsule with the advantage of atmospheric pressure. Creating compressed force in the configurated chamber with the spring absorption stops the principal capsule. It pumps the amount of water displaced in the principal capsule back to the upward tank. The chamber is filled with air (atmospheric pressure) before the capsule enters. More pressure is built with the presence of the capsule velocity at the entry as pressure is inversely proportional to the speed. More force opposing the movement of the capsule is created to stop the principal capsule. The pressure built in the chamber is oriented to the air exhaust configured to allow the pump piston rod and a plurality of air push holes in the section to be pushed down. Creating a force to pump the water into the water pump system (WPS) to the upward tank to compensate for the amount displaced to do the work and exhaust additional extra air force. The second force for pushing the water pump piston to its final position is the weight of the principal capsule tank (PCT) entering the chamber, which moves the remind position of the rod to its final position. The two systems of spring absorption install for the final stop of the principal capsule tank (PCT) and on top of the secondary capsule tank (SCT), allowing a complete stop. The hydro energy is created in the upward tank discharge to quickly fill the principal capsule tank (PCT). The second hydro energy is created at the discharge of the downward tank. At the sucking lines of each water pump system (WPS), pull the pump rod to the top with the movement of the principal capsule tank (PCT), traveling back to its initial position for the next cycle. Engaging the top actuator during the secondary capsule tank (SCT) pull back.

### OVERVIEW

A plurality of a principal capsule tank (PCT) of the present invention filled with water each to provide more weight and hold at an initial position on top with the capsule catcher system (CCS). A plurality of a secondary capsules tank (SCT) aligned at an initial position at the bottom filled up with sand adjusted to be superior to the total empty weight of the principal capsule tank (PCT). When the user pushes the start button first principal capsule tank (PCT) is released from the principal capsule catcher system (CCS), traveling from top to the bottom. This travel produces mechanical energy transmitted to the rotary table to be converted to rotary energy. The total friction of the system plus the total weight of the secondary capsule tank (SCT) are always less than the full principal capsule tank (PCT) filled with water. The principal capsule tank (PCT) enters a Brake-Pump Chamber (BPC) at the end of this first piston. The internal command mechanical switch at the entry of the chamber is a double activator communicating simultaneously with the second soyos drop piston (SDP) to release his principal capsule catcher system (CCS) to drop the second principal capsule tank (PCT). The second is to connect a second clutch to a second rotary table coupled to a clean energy collector (CEC). On the opposite side, at the same time, the secondary capsule tank (SCT) engages the push connection on top to disconnect the clutch to free the first soyos drop piston (SDP). A rearrangement comprises: emptying the principal capsule tank (PCT) and traveling back to the principal capsule tank (PCT) to be filled, ready to repeat the same stroke cycle. This cycle is repeated one soyos drop piston (SDP) after another from first to last and the last to first for continuous cycle operation. The first capsule enters the Brake-Pump chamber at a large speed. The entry creates a strong force in the chamber that is inversely proportional to the capsule's speed configured to provide the opposite force to stop the principal capsule tank (PCT). At the same time, the principal capsule drop valve is pushed with a long bare oriented in the chamber for opening a dropped valve to empty the principal capsule tank (PCT). The water is dropped and orientated to the fill line of the downward tank. The principal capsule tank (PCT) will completely stop with the spring absorber seat on the bottom of the chamber and the spring absorber seat on top of the secondary capsule tank (SCT). The water is a drop, oriented to the downward tank to be pulled into the water pump system (WPS) to pump back to the upward tank. The weight of the secondary capsule tank (SCT) is superior to the empty principal capsule tank (PCT). It is configurated to allow the principal capsule tank (PCT) to drop the water completely within the distance of the chamber. The system balance and the principal capsule tank (PCT) will travel back to the top initial position and push the mechanical control to pull back the large flat head of the pump piston to suck the water from the downward tank for the next cycle of pumping. This first initial position is named the “pullback system.”

A system and method for producing clean, sustainable, and accessible energy with air, water, and sand as a power source to create compressed air energy, hydro energy, mechanical energy for internal work exchange, and clean power delivery. A soyos environment clean engine (SECE) combines a method using water, air, and sand in an enclosed space configured as a clean power source. A way of mounting water in an enclosed space to generate mechanical energy. A way of mounting sand in the tank to customize timing and create mechanical energy is needed to travel back the principal capsule tank in initial positions and pull water into the pump chamber. Opening a tank to the atmospheric air to allow the capsule in motion to break and pump water back to the top tank. Multiple units of the present invention can be installed and attached to the solid upward structure for easy maintenance access and changing different sizes.

Even though numerous characteristics and advantages of the present invention have been outlined in the preceding description, together with details of the structure and function, the disclosure is illustrative only. Change may be made in detail, especially in the matter of shape, size, and arrangement of parts within the principles of the invention to the full extent indicated by the broad general meaning of the term in which the appended claims are expressed.

What is claimed is:

1. A system for producing clean, sustainable, and accessible energy with air, sand, and water (ASW) as power sources, a soyos environment clean engine (SECE) comprises:
a solid upraise structure (SUS);
a clean stroke maker (CSM) system;
a plurality of automatic internal command system (ICS);
the solid upraise structure (SUS) wherein a plurality of solid horizontal support is aligned vertically, a plurality of left-wing attached in serial with a plurality of right-wing forming the main structure size receiving the clean stroke maker (CSM) system, an upward tank is attached at the top to be at the center, a downward tank mounted at the bottom, located bellow the upward tank and seated on top of a plurality of strong customized footing aligned equally on left and right side forming a quadrilateral wherein solid vertical stand support being attached and can be detached;
the clean stroke maker (CSM) system being attached to the solid upraise structure (SUS) comprises a plurality of soyos drop piston (SDP) being aligned and mounted parallelly wherein a plurality of rotary table system (RTS), a plurality of principal capsule catcher system (CCS) attached to the top of the solid upraise structure (SUS);
the plurality of automatic internal command system (ICS) being communicating in order with a mechanical motion of a plurality of soyos drop piston (SDP) to a plurality of mechanical actuator controls activating and deactivating a plurality of a clutch system, opened and closed water in the upward tank.

2. A system for producing clean, sustainable, and accessible energy with air, sand, and water (ASW) as power sources, a soyos environment clean engine (SECE) comprising:
a solid upraise structure (SUS);
a clean stroke maker (CSM) system;
a plurality of automatic internal command system (ICS);
a clean energy collector (CEC);
a customized Torque-Speed builder (CTS);
the solid upraise structure (SUS) with a left-wing extended with a right-wing both aligned parallelly and elevated mounted with the clean stroke maker (CSM) system vertically attached supporting the total structure of the soyos environment clean engine (SECE) in elevation;
the plurality of automatic internal command system (ICS) connected with internal command line attached to a plurality of soyos drop piston (SDP) in serial of two with the motion of both capsules, air force created in chamber, and water flow of both discharge tanks;
the plurality of rotary table system (RTS) located at the bottom is at the center of both capsules connected with a chain wire system coupled at the center to at least a clean energy collector (CEC) outputting clean energy collected to the customized Torque-Speed builder (CTS).

3. A system for producing clean, sustainable, and accessible energy with air, sand, and water (ASW) as power sources, a soyos environment clean engine (SECE) as claimed in claim 1, wherein the clean strokes maker system (CSM) comprises a plurality of soyos drop piston (SDP), each plurality of the soyos drop piston comprises at least:
one principal vertical travel line (VTL);
one secondary vertical travel line (VTL);
one rotary table system (RTS);
one principal capsule catcher system (CCS);
two ahead angle extender system;
the principal vertical travel line (VTL) is elevated parallelly with the secondary vertical travel line (VTL), both aligned and connected with a power transmission chain drive with at least one rotary table system (RTS);
the principal capsule catcher system (CCS) is mounted on top of the principal vertical travel line (VTL) with a capsule arm elongated with a finger;
the two ahead angle extender system wherein: at least one is mounted at the top of the principal vertical travel line (VTL), and the second is mounted at the top of the secondary vertical travel line (VTL); both vertical travel line (VTL) comprises at least one main solid support located at the top of each connected with an angle adjuster block mounted with hand customized angle on the main solid support, the ahead angle extender system being adjusted giving angle alignment orientation to the capsules size change, and rotary table system (RTS) size change.

4. A system for producing clean, sustainable, and accessible energy with air, sand, and water (ASW) as power sources, a soyos environment clean engine (SECE) as claimed in claim 1, wherein an upward tank attached to the top at the center of the solid upraise structure (SUS) comprising: at least one tank body connected at the center on top with at least one drop control case facing the bottom, at least one pipe air control connected to the opposite side both being extended to the left and right with a fill-up manifold elongated and being connected to a plurality of a discharge line of the main water pump (MWP) system; the at least one bottom booster tank installed at the bottom of the front upward tank at the center connected to the discharge manifold on the left and right side and extended to be connected with a plurality of wye filler system (WFS).

5. A system for producing clean, sustainable, and accessible energy with air, sand, and water (ASW) as power sources, a soyos environment clean engine (SECE) as claimed in claim 1, wherein a downward tank attached to the bottom comprising: at least one tank body; a fill up manifold connected to a plurality of drop control pipe mounted to a plurality of drop containment tank, two open maintenance access system being installed at the left end and right end of drop fill up manifold; the at least one discharge manifold connected with a plurality of water pulling control, two open maintenance access system being installed at the end on left and right discharge manifold; the at least one bottom booster tank installed and opened inside the bottom center of the main tank and connected to a left discharge manifold pipe and to a right discharge manifold pipe; the at least one drop control pipe installed on top at the center of the tank comprising at least one left main pipe, at least one right main pipe both connected to a plurality of drop reservoir discharge, at least one left two way drop pipe oriented to the bottom of the tank, at least one right two way drop pipe oriented to the bottom of the tank both horizontally attached to the left main pipe and right main pipe; at least two antifreeze reservoir tank both installed on top of the tank body and connected together at the bottom with one communication pipe, a closure cap with a thermostat is installed on top of the right antifreeze reservoir to control the downward tank filling with temperature, the left antifreeze reservoir comprising a second closure cap with an extend pipe to the communication pipe connected to the right antifreeze reservoir, one discharge pipe with at least one valve oriented on the bottom of the tank installed on the middle of the communication pipe.

6. A system for producing clean, sustainable, and accessible energy with air, sand, and water (ASW) as power sources, a soyos environment clean engine (SECE) of claim 1, wherein a plurality of soyos drop piston (SDP) comprises a plurality of a principal capsule catcher system (CCS) attached to the top of solid upraise structure (SUS); wherein each principal capsule catcher system (CCS) comprising at least one left arm with a finger, at least one right arm with a finger; a spring stabilizer installed between both arms, a solid extend bar elevated on top of the spring stabilizer, a mechanical wire support attached to a solid extend bar, a left swivel pulley attached to the left and a right swivel pulley attached to the right both being attached to the solid extend bar, a strong mechanical wire attached to the bottom of the left arm and the right arm, a mechanical wire pipe juxtaposed the bottom of both left and right mechanical wire to one mechanical wire going through a mechanical wire pipe to mechanicals control switches.

7. A system for producing clean, sustainable, and accessible energy with air, sand, and water (ASW) as power sources, a soyos environment clean engine (SECE) as claimed in claim 2, comprising a clean energy collector (CEC) comprising: a main shaft wherein the main sprocket is mounted at the center; a plurality of input sprocket being horizontally aligned on both sides of the main sprocket with a left flywheel and a right flywheel; the plurality of input sprocket is connected with a chain to a plurality of a retract clutch system (RCS) receiving a sequential mechanical rotational energy output driving the input sprocket; the main sprocket at the center receiving continuous clean energy to be coupled with a chain to a driven sprocket of a customized Torque-Speed builder (CTS).

8. A system for producing clean, sustainable, and accessible energy with air, sand, and water (ASW) as power sources, a soyos environment clean engine (SECE) as claimed in claim 2, comprising the customized Torque-Speed builder (CTS) wherein: a plurality of driving gear are connected to a plurality of driver gear forming a plurality of output delivery, coupled with a plurality of compound gear and a plurality of idle gear allowing change in rpm and power output; a plurality of gear ratio adjuster outputting a high torque shaft delivery and a high rpm shaft delivery; a plurality of flywheel are mounted and connected to form an adjusted system to install different size of the component customizing output to low torque shaft delivery and to low rpm shaft delivery for soyos environment clean engine (SECE) being multifunction clean power output.

9. A system for producing clean, sustainable, and accessible energy with air, sand, and water (ASW) as power sources, a soyos environment clean engine (SECE) of claim 3, comprising a plurality of soyos drop piston (SDP) wherein each soyos drop piston (SDP) comprise:
a principal vertical travel line (VTL);
a secondary vertical travel line (VTL);
a principal capsule tank (PCT) retainer;
the principal vertical travel line (VTL) mounted with a wye filler system (WFS) at the top, at least two solid bars mounted vertically connecting the entry to the interior of a brake-pump chamber (BPC) to the principal capsule tank (PCT), at the bottom;
the secondary vertical travel line (VTL) is mounted at least with two spring absorbers both attached to the top being aligned with at least two spring absorber seats, and at least one solid tube actuator aligned with the secondary capsule tank (SCT) is connected to a mechanical cable to deactivate a lower pyramidal long tube and upper pyramidal long tube disengaging a retract clutch system (RCS) from a rotary table system (RTS), at least two solid bars mounted vertically wherein the secondary capsule tank (SCT) being attached with wheel system to be at the opposite position of the principal capsule tank (PCT);
the principal capsule tank (PCT) retainer being installed proximate to the final top position of the principal capsule tank (PCT) elongated with two arms, using the upper-end movement of the principal capsule tank (PCT) to set fingers to retain, in opposite using a second soyos drop piston (SDP) engaging at the entry of brake-pump chamber (BPC) a long flat tube to release fingers.

10. A system for producing clean, sustainable, and accessible energy with air, sand, and water (ASW) as power sources, a soyos environment clean engine (SECE) of claim 3, comprising a plurality of rotary table system (RTS), each plurality of the rotary table system (RTS), comprise a strong drive central sprocket being mounted at the center with wire bearing and a retract clutch system (RCS), communicatively with the automatic internal command system (ICS) engaging and disengaging the rotary table to the clean energy collector (CEC), all attached to the top of a plurality of solid support, the driving sprocket being at the center-aligned with the two solid elevated bar on each side being connected with principal capsule tank (PCT) to be in opposite position with secondary capsule tank (SCT), the rotary table is connected to both capsules with a solid power transmission long chain wire drive traversing the central sprocket and wire baring.

11. A system for producing clean, sustainable, and accessible energy with air, sand, and water (ASW) as power sources, a soyos environment clean engine (SECE) as claimed in claim 9, the principal capsule tank (PCT) comprising the main tank, a cone-shaped on the bottom, a square pyramid with a least one principal filling hole and a secondary filling hole located on the top, the bottom is mounted with the left retainer seat and the right retainer seat, a quick drop valve being mounted at the bottom of the main tank wherein a disc with a spring forming a seal is attached, an extender opener mounted to be aligned with solid tube actuator on brake-pump chamber (BPC), a floater mounted inside of the tank, a filler head located on top of the tank and aligned with the two filling hole, the principal capsule tank is mounted on the principal vertical travel line (VTL) with left and right wheel system.

12. A system for producing clean, sustainable, and accessible energy with air, sand, and water (ASW) as power sources, a soyos environment clean engine (SECE) as claimed in claim 4, comprising the secondary capsule tank (SCT) comprising a body cylinder located at the center, a top cone mounted with a loading door oriented to the top, a bottom cone mounted with an offload door oriented to the bottom, a level meter mounted with sign glass, a left spring absorber seat mounted with a right spring absorber seat to be aligned with both the spring absorber located at the top, a chain cable attaches is mounted on the top cone, a sand retainer elongated to exterior with the tight throttle, the secondary capsule tank (SCT) is mounted on the secondary vertical travel line (VTL) with left and right wheel system being operated at the opposite direction of the principal capsule tank (PCT).

13. A system for producing clean, sustainable, and accessible energy with air, sand, and water (ASW) as power sources, a soyos environment clean engine (SECE) as claimed in claim 5, wherein a plurality of the wye filler system (WFS) attached to the top, each wye filler system (WFS) comprising a main one-way valve comprises a disc mounted with a spring to a disc seat, a tube extender with a wire, connected the floater extender bar to control open and close of the disc, the left discharge pipe elongated to the right discharge pipe both connected to the main pipe being mounted to the upward tank discharge manifold line.

14. A system for producing clean, sustainable, and accessible energy with air, sand, and water (ASW) as power sources, a soyos environment clean engine (SECE) as claimed in claim 9, comprising: a plurality of retract clutch system (RCS), each retract clutch system (RCS) configured to engage and to disengage the clutch system with pulling mechanical wire system, comprising: a lower pyramidal long tube; an upper pyramidal long tube both connected to a mechanical cable on both side; a flexible disc; a solid disc; a mechanical cable pipe; a mechanical cable; a right solid support; a right cable pulley system; a left solid support; a left cable pulley system; a retract and extender control; the lower pyramidal long tube mounted horizontally proximate to the center, the upper pyramidal long tube mounted horizontally proximate to the center both pyramidal long tube located between the flexible disc and the solid disc; the left solid support and the right solid support being configured to support and to carry the mechanical cable pipe orientation, a pyramidal long tube retainer installed between the right solid support and the solid disc, on right side, two mechanical cable connected the both end of upper and lower pyramidal long tube traversing the right cable pulley system to the mechanical cable pipe to be connected to the retract clutch take off mechanical control, on left side, two mechanical cable connected the both end of upper and lower pyramidal long tube traversing the left cable pulley system to the mechanical cable pipe being connected to the a mechanical switch installed at the top of the principal capsule brake-pump chamber (BPC) entry.

15. A system for producing clean, sustainable, and accessible energy with air, sand, and water (ASW) as power sources, a soyos environment clean engine (SECE) as claimed in claim 9, comprising a brake-pump chamber (BPC) attached at the bottom of the principal vertical rail, comprising: at least one main chamber; one cap mounted at the top; one drop containment tank attached to the bottom; a capsule brake entry configured to the shape of the principal capsule tank (PCT); a principal capsule drop valve housing oriented from top to bottom; a large head flat pump rod extended inside the main chamber; a left absorber head and a right absorber head installed at the bottom of the main chamber; a water control connected to drop containment tank; at least one solid tube actuator installed on left of the cap and oriented vertically from top to the bottom, a mechanical switch installed at the top of the capsule brake entry wherein a long flat tube being install on a solid support forming a reverse Tee; an extension spring to extend and retract the solid tube traversing the solid support to connect with the center of the long flat tube, the opposite end forming a tee and the two control cable being connected.

16. A system for producing clean, sustainable, and accessible energy with air, sand, and water (ASW) as power sources, a soyos environment clean engine (SECE) as claimed in claim 15, comprising a Mechanical switch installed at the top of the capsule brake entry comprises: a long flat tube being installed to extended support on large solid support forming a reverse Tee; a mechanical cable connected the long flat tube with one pulley oriented to the tube line to the second principal capsule tank retainer, a second pulley oriented to the tube line to the second retract clutch system (RCS); an extended spring is installed on the solid tube extended in tee between the top two cable line connection and the extended tube connected the long flat tube.

17. A system for producing clean, sustainable, and accessible energy with air, sand, and water (ASW) as power sources, a soyos environment clean engine (SECE) as claimed in claim 9, comprising a plurality of main water pump (MWP) system wherein each of the plurality main water pump (MWP) system comprising: a strong cover with an inclined surface installed at the top of a large water cylinder pump both mounted at the bottom of a drop containment tank with a drain hole; a long piston rod extended in a brake-pump main chamber ended with a large head flat pump rod wherein a plurality of air push hole, a cone-shaped seat and a pulling connection head installed on the top, a left spring absorbers head and a right spring absorbers head mounted on top of the strong cover to receive the bottom of the large head flat pump rod; a plurality of an exhaust air system wherein each is located at the bottom of the strong cover facing the ground and extended with a pipe ending with an exhaust control valve mounted in the brake-pump main chamber; a discharge line with a water pumping control wherein, one-way valve mounted with a control air system; a fill line with a water pulling control wherein one-way valve mounted with a control air system.

18. A method for internal communication producing clean, sustainable, and accessible energy with air, sand, and water (ASW) as power sources, a soyos environment clean engine (SECE) comprising:
a method of communication for operating a soyos environment clean engine (SECE);
a method of communication for operating a clean energy collector (CEC);
the method of communication for operating a soyos environment clean engine (SECE) wherein a starting module sending a communication signal to the first module to lunch a soyos drop piston (SDP1) of a first independent system wherein: a first option response of not being ready sending a message back to restart the starting module, the second option message being ready communicating directly with a second module to transfer a mechanical energy wherein a first message sending to a third module on a rotary table system 1 (RTS1) with clutch communicating with C and the second message communicating to a different two modules at the same time comprising: a first module deactivate clutch system on soyos drop piston (SDP1) receiving a message and communicating directly with the third module rotary table system (RTS1) with clutch, a second module to activate soyos drop piston (SDP2) with Clutch 2 receiving a message and communicating directly with a first module of a second independent system starting a second independent system 2, the module soyos drop piston (SDP2) communicating directly with a module to transfer a mechanical energy of system 2 wherein a first message sending to a module of rotary table system (RTS2) with clutch communicating with D and the second message sent to communicate directly to a different two modules at the same time comprising a module deactivating clutch system on soyos drop piston (SDP2) receiving a message and communicating directly with a module rotary table system (RTS2) with clutch, a module activate soyos drop piston (SDP3) with Clutch 3 receiving a message and communicating directly with a first module soyos drop piston (SDP3) of an independent system 3, starting a third independent system 3, the module soyos drop piston (SDP3) receiving a message and communicating directly with a module transfer a mechanical energy of system 3 wherein a first message sending to a module rotary table system (RTS3) with clutch communicating with E and the second message sent to communicate directly to a different two modules at the same time comprising a module deactivating clutch system on soyos drop piston (SDP3) receiving a message and communicating directly with a module of rotary table system (RTS3) with clutch, a module activate soyos drop piston (SDP4) with Clutch 4 receiving a message and communicating directly with a first module soyos drop piston (SDP4) of an independent system 4, starting a fourth independent system 4, the module soyos drop piston (SDP4) receiving a message and communicating directly with a module to transfer a mechanical energy of system 4 wherein a first message sending to a module of rotary table system (RTS4) with clutch receiving a message and communicating with F and the second message sent to communicate directly to a different two modules at the same time comprising a module deactivating clutch system on soyos drop piston (SDP4) receiving a message and communicating directly with a module of rotary table system (RTS4) with clutch, a module to activate soyos drop piston (SDP5) with Clutch 5 communicating with a first module soyos drop piston (SDP5) of an independent system 5, starting a fifth independent system 5, the module soyos drop piston (SDP5) receiving a message and communicating directly with a module to transfer a mechanical energy of system 5 wherein a first message sending to a module of rotary table system (RTS5) with clutch receiving a message and communicating with G and the second message sent to communicate directly to a different two modules at the same time comprising a module deactivating clutch system on soyos drop piston (SDP5) receiving a message and communicating directly with a module of rotary table system (RTS5) with clutch, a module to activate soyos drop piston (SDP6) with Clutch 6 receiving a message and communicating with a first module soyos drop piston (SDP1) of the first independent system 1, starting a new cycle, a stop module communicating with a module locating a position wherein a first option of message sending back to the stop module to repeat the message, the position located a message sending to an activate stop module receiving a message and responding directly sending a message to a located position module activate soyos drop piston (SDP) with clutch to receiving a message and responding to stop the engine;
the method of communication for operating a clean energy collector (CEC) comprises a plurality of input messages to a plurality of a receiving message wherein a continuous receiving module sends a message to a first decision module communicating back with a receiving module fixing the input and restarting automatically, sending a message to a second decision module wherein: the first message sending to an rpm receiving module and a second message sending to a torque receiving module.

19. A method for internal communication producing clean, sustainable, and accessible energy with air, sand, and water (ASW) as power sources, a soyos environment clean engine (SECE) as claimed in claim 18 comprising:
a communication for operating a soyos environment clean engine (SECE);
a communication for operating a clean energy collector (CEC);
a step and communication for activating and deactivating a clutch on a rotary table system (RTS);
a communication of one complete cycle timeline for operating a clean stroke maker system (CSM);
the step and communication for activating and deactivating a clutch on a rotary table system (RTS) comprises: a first step of communication wherein a module activates soyos drop piston (SDP) with clutch sending a message communicating with a principal module rotary table system (RTS) with clutch receiving a message and responding to a module connecting with the rotary table system (RTS) engaging both modules, the second step of communication retracting a clutch wherein a module deactivate clutch system on soyos drop piston (SDP) receiving a message and communicating with a principal module rotary table system (RTS) with clutch receiving a message and responding to a module disconnecting from rotary table system (RTS).

20. A method for internal communication producing clean, sustainable, and accessible energy with air, sand, and water (ASW) as power sources, a soyos environment clean engine (SECE) as claimed in claim 19 comprising: a communication of one complete cycle timeline for operating a clean stroke maker (CSM) system; the cycle timeline shows the entire one cycle operating a clean stroke maker system (CSM) wherein a central timing module C receives a plurality of operation message from the duration of a plurality input module T wherein receiving a plurality timing message from a plurality activity module soyos drop piston (SDP).
